(19) United States
(12) Patent Application Publication
(10) Pub. No.: US 2006/0164834 A1
(43) Pub. Date: Jul. 27, 2006

(54) Power distributor for christmas tree

(76) Inventor: Fang-Cheng Kao, Taipei (TW)

Correspondence Address: RABIN & Berdo, PC, 1101 14TH STREET, NW, SUITE 500, WASHINGTON, DC, 20005, US

(21) Appl. No.: 11/038,168

(22) Filed: Jan. 21, 2005

(51) Int. Cl. F21V 21/00

(52) U.S. Cl. 362/249

(57) ABSTRACT

Disclosed is a power distributor for a Christmas tree, including a case having a cylindrical inner wall defining a central bore fit over a trunk of the Christmas tree and an outer wall spaced from and surrounding the inner wall to define an interior space therebetween for receiving a circuit board. The circuit board forms a control circuit that is electrically connected an external power source to receive power therefrom and forms a plurality of electrical receptacles each electrically engaging one light string of the Christmas tree. The control circuit includes a control device for controlling power supplied to each light string in a predetermined mode, which is selectively a continuous lighting of the light string or a variety of blinking patterns of the light strings.

### BACKGROUND OF THE INVENTION

1. Field of the Invention

The present invention relates generally to a Christmas tree, and in particular to a power distributor for the Christmas tree that allows for easy set-up of lights around the Christmas tree and provides a variety of blinking patterns for the lights of the Christmas tree.

2. The Prior Arts

Setting up a Christmas tree is a tradition during Christmas. Business establishment use decorated Christmas trees to attract customers. Families decorate their Christmas trees together to celebrate Christmas. However, people are often irritated by the work of wrapping lights around their trees. Thus, the use of prelit Christmas trees becomes more and more common among consumers.

Yet, to this date, the conventional prelit tree has drawbacks. The prelit trees that are available in the market do not have blinking variation. The known prelit tree is not easy to set up because a number of extension cords are needed in setting up the prelit tree. The complicated structure of the conventional prelit tree also trouble general consumers in that it is not easy to repair defective bulbs. Further, it is not possible for the general consumers to do repairing for a major defective, because there are no additional service parts available.

It is thus desired to have a power distributor that allows for easy set-up of lights around a Christmas tree, while providing a variety of blinking patterns of the lights in order to overcomes the drawbacks of the conventional prelit trees.

### SUMMARY OF THE INVENTION

An objective of the present invention is to provide a power distributor for a Christmas tree that allows lights to be easily wrapped around the Christmas tree without extension cords whereby establishment of the Christmas tree can be done easily.

Another objective of the present invention is to provide a power distributor for a Christmas tree comprising a control box for providing a variety of blinking patterns for lights surrounding the tree.

A further object of the present invention is to provide a power distributor for a Christmas tree for powering lights surrounding the Christmas tree, which allows for easy replacement of defective bulbs.

A further object of the present invention is to provide a power distributor for a Christmas tree of which spare parts are easily available.

In accordance with the present invention, to realize the above objectives, a power distributor for a Christmas tree is provided, comprising a case having a cylindrical inner wall defining a central bore fit over a trunk of the Christmas tree and an outer wall spaced from and surrounding the inner wall to define an interior space therebetween for receiving a circuit board. The Christmas comprises a branch holder forming a plurality of slots for removably receiving and releasably retaining branches each supporting a light string, whereby the branch and the associated light string can be easily replaced. The circuit board forms a control circuit that is electrically connected an external power source to receive power therefrom and forms a plurality of electrical receptacles each electrically engaging one light string of the Christmas tree. The control circuit comprises a control device for controlling power supplied to each light string in a predetermined mode, which is selectively a continuous lighting of the light string or a variety of blinking patterns of the light strings. If desired, a control box can be additionally provided for controlling the blinking of the light strings.

The present invention will become more obvious from the following description when taken in connection with the accompanying drawings, which show, for purposes of illustration only, preferred embodiments in accordance with the present invention. In the drawings:

### BRIEF DESCRIPTION OF THE DRAWINGS

FIG. 1 is an elevational view of a Christmas tree in which a power distributor constructed in accordance with the present invention is incorporated;

FIG. 2 is a perspective view of the power distributor of the present invention;

FIG. 3 is an exploded view of the power distributor of the present invention;

FIG. 4 is a perspective view showing the connection between the power distributor and a light string entangled with a tree branch; and

FIG. 5 is a perspective view showing a branch holder that retains the branch to a trunk of the Christmas tree.

### DETAILED DESCRIPTION OF THE PREFERRED EMBODIMENTS

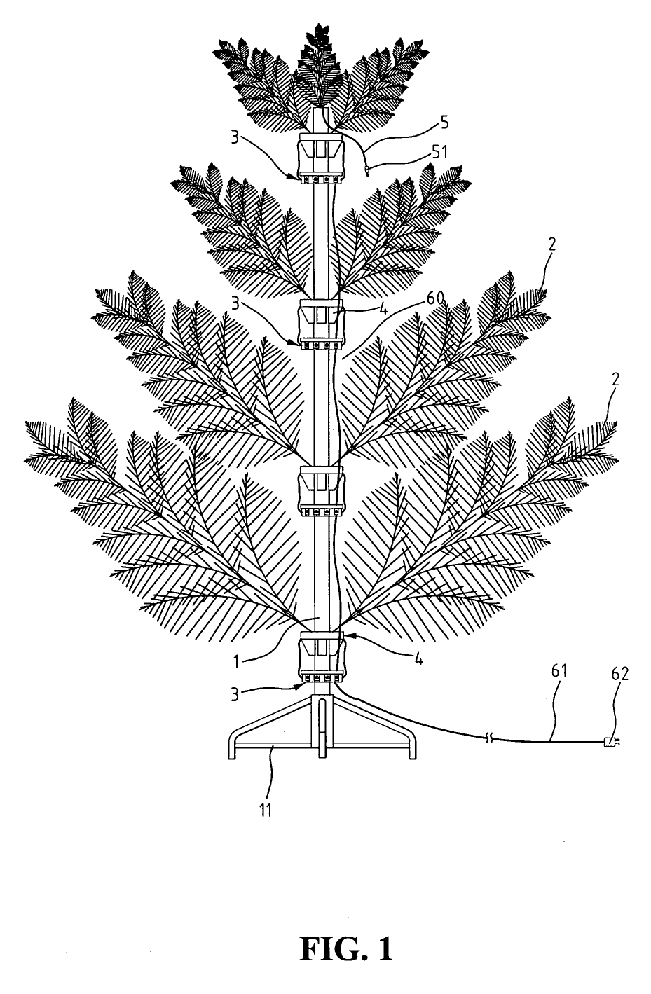

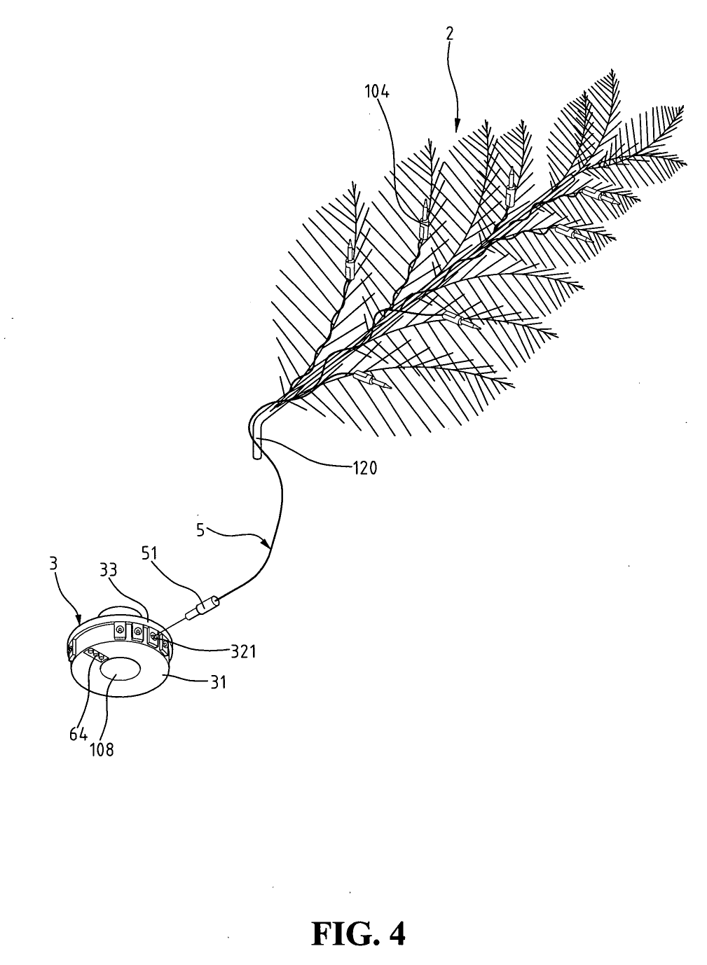

With reference to the drawings, and in particular to FIG. 1, a Christmas tree, generally designated with reference numeral 100, comprises a stand 11 from which a trunk 1 vertically extending. A plurality of branch holders 4 are mounted to and spaced along, preferably with equal distance, the trunk 1 to support and retain branches 2. Each branch 2 supports a light string 2 (FIG. 4) composed of electrical wires 102 entangling the branch 2 and a number of light bulbs 104 electrically and mechanically mounted to the wires 102.

In accordance with an aspect of the present invention, a plurality of power distributors, generally designated with reference numeral 3, is mounted to the trunk 1 for controlling power supply to the light string 5. Preferably, the power distributors 3 are equally spaced along the trunk 1 with fixed pitch. In this case, the number of the power distributors 3 is determined by the overall length of the trunk 1 and the pitch between power distributors 3. Alternatively, the power distributors 3 may be arranged at variable pitches.

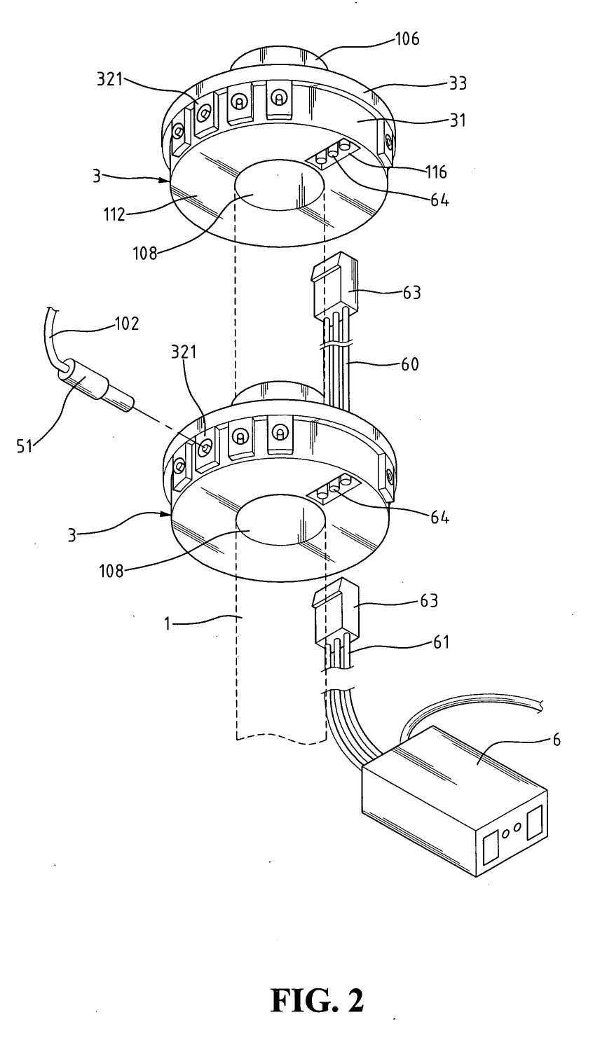

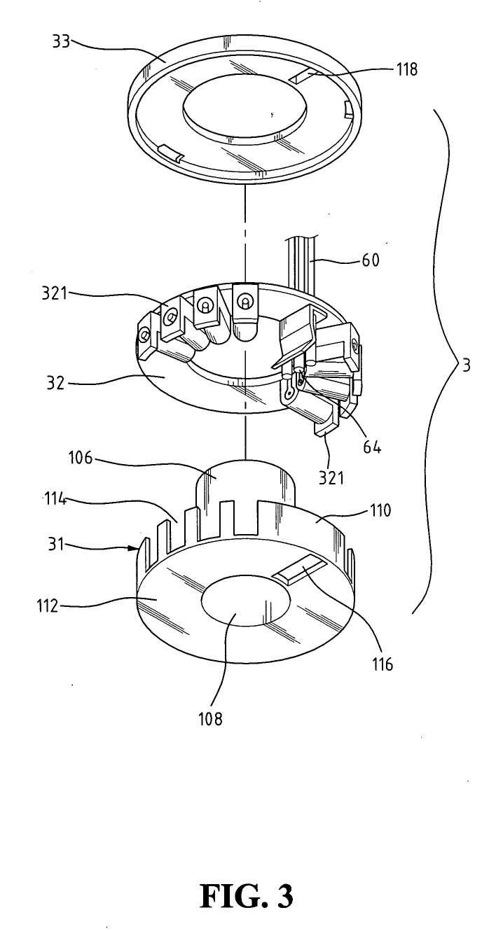

Also referring to FIGS. 2 and 3, the power distributor 3 comprises a case 31, preferably made of insulation material, comprising a cylindrical inner wall 106 that defines a central bore 108 fitting over the trunk 1 of the Christmas tree 100, an outer wall 110 that is substantially concentric with and radially spaced from the inner wall 106, and a ring-shaped bottom 112 connecting between the inner and outer walls 106, 110 to define a ring-shaped interior space (not labeled). Securing means (not shown) may be provided to fix the case 31 to the trunk 1, or alternatively, the case 31 can be simply secured by friction between the inner wall 106 of the case 31 and the trunk 1.

A circuit board 32, in the form of a ring, is snugly received in the interior space of the case 31, comprise a circuit (not shown) formed thereon. A plurality of electrical receptacles 321 is mounted to the circuit board 32 and is in electrical connection with the circuit of the circuit board 32. An opening 114 is defined in the outer wall 110 of the case 31 to expose each receptacle 321. Also a window or opening 116 is defined in the bottom 112 for the extension of an electrical cable 60 that electrically connects the circuit board 32 to other power distributors 3 or to an external power supply, such as a wall outlet (not shown) in which case an extension cord 61 having an end plug 62 is used to connect the power distributors 3, as well as the electrical cables 60, to the wall outlet. Preferably, the engagement between the electrical cable 60 (or the extension cord 61) and the associated circuit board 32 is realized by a releasable plug-socket pair (63, 64), see FIG. 2. This allows for easy establishment of electrical connection between the power distributors 3 and the external power source.

A lid 33 is fit over a top opening of the case 31 to close the interior space of the case 31 and to shield the circuit board 32 for dust-proof and protection of undesired contact. The lid 33 can be provided with fastening means for securing to the case 31, or tight fitting is employed to secure the lid 33 to the case 31. A window or opening 118 is defined in the lid 33 for the extension of the power cord 60.

Also referring to FIG. 4, the light string 5 that entangle around the branch 2 has a plug 51 that is engageable with, preferably removably, each receptacle 321 of the circuit board 32 to receive electrical power therefrom.

In an aspect of the present invention, the circuit of the circuit board 32 controls power supplied to each light string 5 in an independent manner, which means the light strings 5 are power independently and are not linked to each other, whereby a defective found in one of the light strings 5 does not affect the functionality of other light strings 5. Also, repairing the defective light string 5 can be easily done by replacing with a new one.

In another aspect of the present invention, the circuit board 32 comprises a circuit that is designed to light the light string in a predetermined blinking pattern or a variety of blinking patterns. In other words, blinking control may be realized by a control device incorporated in the circuit. If desired, programmable units may be included in the circuit board 32 to allow a user or a manufacturer to set up different lighting patterns of the light strings. Apparently and alternatively, the circuit board 32 may simply serve to pass electrical current from the cables 61 or cord 60 to the light strings 5 and in this case the circuit board 32 may be replaced by a conductor, such as copper plate.

Optionally, a control box 6 is added between the external power source, such as the wall outlet, and the power distributors 3 for additional control of the blinking patterns of the light strings 5. Alternatively, the control box 6 may simply an adaptor that performs power transformation or other necessary functions. Such a control box 6 is generally known and thus no further detail will be given herein.

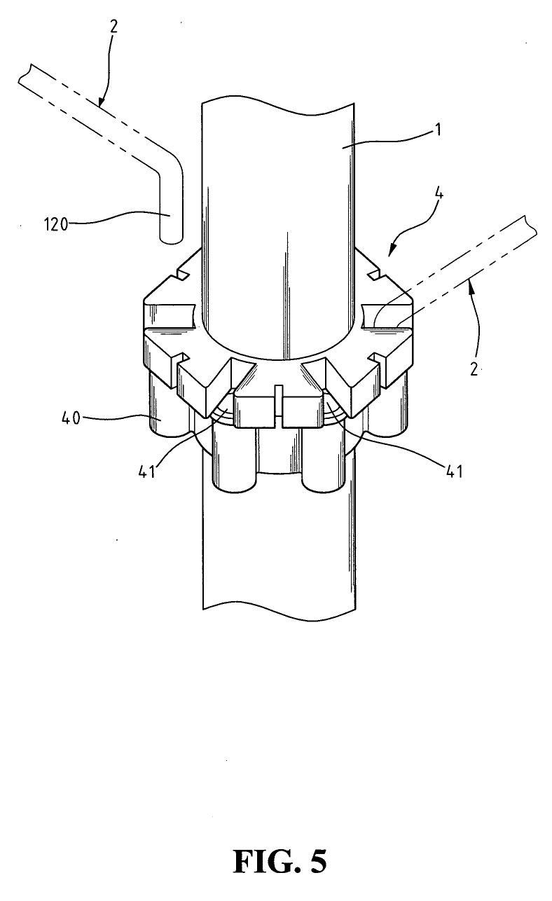

Referring now to FIGS. 1, 4, and 5, each branch 2 has a retention bar 120, which forms an included angle with an axis of the branch 2. The branch holder 4, which is particularly shown in FIG. 5, comprises a base 40 defining a central bore (not labeled) snugly fit over the trunk 1 to retain the holder 4 on the trunk 1. The base 40 defines a plurality of slots 41 sized to tightly receive the retention bar 120 of each branch 2 in a vertical manner whereby the branch 2 extends in an upward inclined manner from the trunk 1 for simulation of a real tree.

In an aspect of the present invention, each branch holder 4 is associated with one power distributor 3 and each branch 2 and the single light string 5 entangling the branch 2 correspond to each receptacle 321 of the circuit board 32 of the power distributor 3. Thus, the light string 5 of each branch 2 is powered by a specific receptacle 321 of the associated circuit board 32. This allows easy identification and repairing or replacement of a defective light string 5.

Preferably, the power distributors 3 and the branch holders 4 are factory fixed on the trunk 1, while the consumers are allowed to put the branches 2 to the branch holders 4 and plug the plug 51 into the receptacle 321 of the circuit board 32 to establish mechanical and electrical connection between the branches 32 and the light strings 5 and the trunk 1.

It can be concluded from the above-described invention that (1) since each branch only occupies a small area of the Christmas tree, it is not noticeable if the light strings of one or several branches do not work properly; (2) trouble created by the complicacy of wiring of the conventional Christmas trees can be eliminated; (3) the Christmas tree of the present invention can be easily assembled/disassembled and stored; and (4) no more hassle of sending back a defective Christmas tree for repair or replacement because the branches and the light string associated therewith, and other parts, are replaceable by the consumers. The replaceability of all parts of the Christmas tree of the present invention also benefits the Christmas tree sellers for there is no need to refund for defective trees.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An artificial decorative lighting tree comprising:
a trunk extending upright;
one power distributor and one branch holder both defining a central bore fit over and retained on the trunk, wherein:
the branch holder forming a slot, and
the power distributor forming an electrical receptacle;
a branch having a retention bar forming an angle with respect to an axis of the branch, the retention bar being receivable in the slot to support the branch on the trunk at the angle;
a light string comprising electrical wires entangling the branch and lighting elements electrically connected to the wires, the wires forming a plug receivable and electrically engageable with the receptacle to receive electrical power therefrom;
a power cord adapted to connect the power distributor to a power source.

2. The artificial decorative lighting tree as claimed in claim 1, wherein the branch holder forms a number of slots along a circumference thereof, each receiving and supporting one branch, and wherein the power distributor forms a corresponding number of receptacle each engageable with the plug of the light string of each branch.

3. The artificial decorative lighting tree as claimed in claim 1 further comprising a next power distributor mounted to the trunk and spaced from said one power distributor with an electrical cable extending between and forming electrical connection with said one power distributor and said next power distributor.

4. The artificial decorative lighting tree as claimed in claim 3, wherein at least one end of the electrical cable forming a plug engageable with a socket formed in one of said one power distributor and said next power distributor.

5. The artificial decorative lighting tree as claimed in claim 3 further comprising a next branch having a next light string mounted thereon, the next light string forming a plug engageable with a receptacle of said next power distributor.

6. The artificial decorative lighting tree as claimed in claim 1 further comprising a stand from which the trunk extends.

7. The artificial decorative lighting tree as claimed in claim 1 further comprising a control box arranged in the power cord to control blinking of the light string.

8. The artificial decorative lighting tree as claimed in claim 1, wherein the power distributor comprises means for controlling blinking of the light string.

9. The artificial decorative lighting tree as claimed in claim 1, wherein the power distributor comprises:
a case having a cylindrical inner wall defining the central bore of the power distributor that fits over the trunk and an outer wall spaced from and surrounding the inner wall to define an interior space therebetween, the outer wall defining an opening corresponding to each receptacle of the power distributor; and
a circuit board received in the interior space and forming a control circuit to which the receptacle is mounted and electrically connected, the control circuit being electrically connected to the power cord.

10. The artificial decorative lighting tree as claimed in claim 9, wherein the control circuit comprises a conductor for passing electrical current from the power cord to the receptacle and the light string received in the receptacle.

11. The artificial decorative lighting tree as claimed in claim 9, wherein the control circuit comprises a blinking control device for controlling blinking of the light string connected to the receptacle.

12. The artificial decorative lighting tree as claimed in claim 9, wherein the power distributor further comprises a bottom connected between the inner and outer walls, an opening being defined in the bottom for forming a socket to receive a plug formed in a proximal end of the power cord.

13. The artificial decorative lighting tree as claimed in claim 12, wherein the power distributor further comprises a lid closing a top opening of the interior space.

14. The artificial decorative lighting tree as claimed in claim 13 further comprising an identical next power distributor mounted to the trunk and spaced from said one power distributor with an electrical cable extending between and forming electrical connection with said one power distributor and said next power distributor.

15. The artificial decorative lighting tree as claimed in claim 14, wherein the lid of said one power distributor forms an opening through which the electrical cable extends from the circuit board of said one power distributor, a remote end of the electrical cable forming a plug engageable with the socket formed in the opening of the bottom of said next power distributor.

16. A power distributor for a Christmas tree comprises:
a case having a cylindrical inner wall defining a central bore adapted to fit over a trunk of the Christmas tree and an outer wall spaced from and surrounding the inner wall to define an interior space therebetween; and
a circuit board received in the interior space, the circuit board forming a control circuit adapted to electrically connect an external power source to receive power therefrom, the circuit board forming a plurality of electrical receptacles each adapted to receive and electrically engage one light string of the Christmas tree, the control circuit comprising means for controlling power supplied to each light string in a predetermined mode.

17. The power distributor as claimed in claim 16, wherein the control circuit comprise a conductor directly connecting between the external power source and the receptacle and the predetermined mode of supplying power to the light string comprises continuously supplying power to the light string through the conductor.

18. The power distributor as claimed in claim 16, wherein the control circuit comprises a blinking control device for controlling blinking of the light string and the predetermined mode of supplying power to the light string comprises powering the light string in a predetermined blinking pattern under the control of the blinking control device.

19. The power distributor as claimed in claim 16 further comprising a bottom connected between the inner and outer walls, an opening being defined in the bottom for forming a connector for connecting with the external power source.

20. The power distributor as claimed in claim 19 further comprising a lid closing a top opening of the interior space.
